(19) United States
(12) Patent Application Publication
(10) Pub. No.: US 2013/0101323 A1
(43) Pub. Date: Apr. 25, 2013

(54) BELT DRIVING DEVICE AND IMAGE FORMING APPARATUS INCLUDING BELT DRIVING DEVICE

(71) Applicant: Canon Kabushiki Kaisha, Tokyo (JP)

(72) Inventor: Tomohito Nakagawa, Kashiwa-shi (JP)

(73) Assignee: CANON KABUSHIKI KAISHA, Tokyo (JP)

(21) Appl. No.: 13/652,727

(22) Filed: Oct. 16, 2012

(30) Foreign Application Priority Data
Oct. 21, 2011 (JP) 2011-232037

(51) Int. Cl. G03G 15/01

(52) U.S. Cl. 399/302

(57) ABSTRACT

A belt member driving device includes an arm configured to be movable with movement of a belt member in a width direction thereof while being in contact with an end of the belt member in the width direction thereof, a first detected portion provided on the arm, a second detected portion provided on the arm and disposed in a position different from that of the first detected portion in a direction perpendicular to a movement direction of the arm on a plane where the arm is moved, a first sensor configured to detect the first detected portion, and a second sensor configured to detect the second detected portion. The second sensor and the first sensor partly overlap each other in the movement direction of the arm as viewed in a direction perpendicular to the movement direction of the arm.

### BACKGROUND OF THE INVENTION

1. Field of the Invention

The present invention relates to a belt driving device that drives a belt member, and an image forming apparatus that includes the belt driving device and forms an image on a recording material.

2. Description of the Related Art

To deal with various recording materials, an image forming apparatus includes a transfer unit that transfers a toner image formed on an image bearing member such as a photosensitive drum to an intermediate transfer member and then transfers the toner image formed on the intermediate transfer member to a recording material.

Japanese Patent Application Laid-Open No. 2008-26676 discusses an apparatus that includes a non-contact distance sensor facing a detected surface integrated with an arm moving in contact with an end of a belt in a width direction thereof to detect a position of the belt travelling in the width direction thereof. However, such a sensor that can continuously detect the position requires higher costs than a sensor such as a photo-interrupter.

Japanese Patent Application Laid-Open No. 2010-223981 discusses a configuration that a roller for stretching an intermediate transfer belt is inclined to suppress deviation of a travelling intermediate transfer belt in a width direction thereof. The inclination amount of the roller is controlled based on a detection result by a detection unit that detects a position of the intermediate transfer belt. An arm that is moved in contact with an end of the intermediate transfer belt in the width direction is disposed to detect the position of the intermediate transfer belt. Further, a plurality of sensors such as photo-interrupters is disposed along a movement locus of the arm to detect a detected portion provided for the arm.

In such a configuration, all the sensors detect the common detected portion, and the sensors are, therefore, arranged adjacent each other. Thus, if an interval between the sensors is to be narrow for fine detection, the sensors hit each other or space necessary for attaching the sensor cannot be reserved. Thus, the arrangement interval between the sensors cannot be narrowed, so that fine detection cannot be realized.

### SUMMARY OF THE INVENTION

According to an aspect of the present invention, a belt member driving device includes a movable belt member, a tension roller configured to stretch the belt member, a driving source configured to drive the belt member, a steering roller configured to stretch the belt member and to be able to incline relative to the tension roller to move the belt member being driven in a width direction of the belt member, an arm configured to be movable with movement of the belt member in the width direction thereof while being in contact with an end of the belt member in the width direction thereof, a first detected portion provided on the arm, a second detected portion provided on the arm and disposed in a position different from that of the first detected portion in a direction perpendicular to a movement direction of the arm on a plane where the arm is moved, a first sensor configured to detect the first detected portion, a second sensor configured to detect the second detected portion, wherein the second sensor and the first sensor partly overlap each other in the movement direction of the arm as viewed in a direction perpendicular to the movement direction of the arm, and a control unit configured to control inclination of the steering roller based on detection results by the first sensor and the second sensor.

According to an exemplary embodiment of the present invention, the second detected portion is arranged in the position different from that of the first detected portion in the direction perpendicular to the movement direction of the arm. In the movement direction of the arm, the second sensor can be, therefore, arranged to partly overlap the first sensor. Thus, the detection can be finely performed.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an explanatory diagram of a configuration of an image forming apparatus according to a first exemplary embodiment of the present invention.

FIG. 2 illustrates a perspective view of an intermediate transfer unit according to the first exemplary embodiment.

FIG. 3 illustrates an explanatory diagram of a planar arrangement of a first frame and a second frame according to the first exemplary embodiment.

FIGS. 4A and 4B illustrate explanatory diagrams of a driving mechanism of a driving roller according to the first exemplary embodiment.

FIG. 5 illustrates an explanatory diagram of a belt detection device according to the first exemplary embodiment.

FIG. 6 illustrates an explanatory diagram of combinations of belt detection positions according to the first exemplary embodiment.

FIG. 7 illustrates an explanatory diagram of a belt detection device according to another exemplary embodiment of the present invention.

FIG. 8 illustrates another explanatory diagram of the belt detection device according to another exemplary embodiment.

### DESCRIPTION OF THE EMBODIMENTS

Various exemplary embodiments, features, and aspects of the invention will be described in detail below with reference to the drawings.

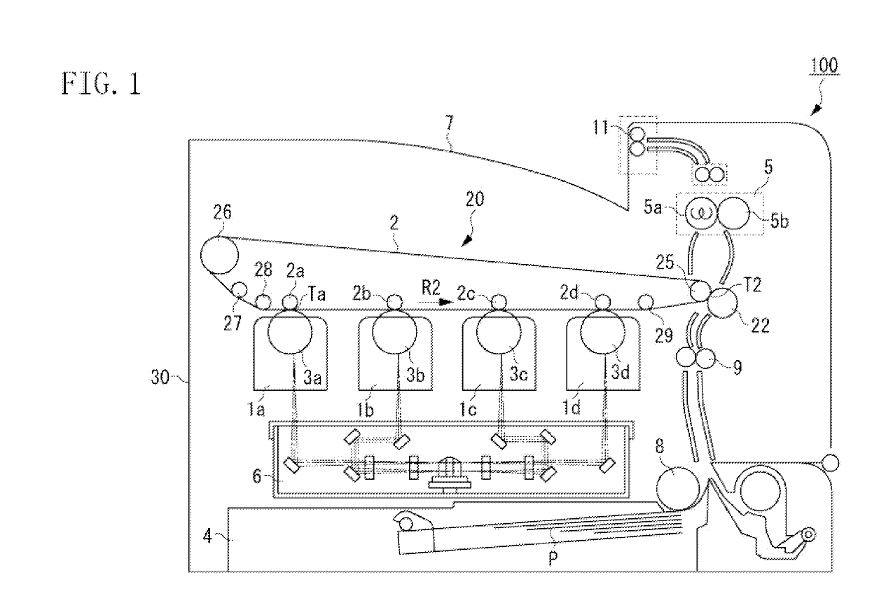

An image forming apparatus 100 is described according to a first exemplary embodiment of the present invention with reference to FIG. 1.

Image forming units 1a, 1b, 1c, and 1d form images. The image forming units 1a, 1b, 1c, and 1d form images by using toners of yellow, magenta, cyan, and black. Other than toners, configurations of the image forming units 1a to 1d are shared. Therefore, the image forming unit 1a is described as an example.

The image forming unit 1a is assembled as a replaceable unit (process cartridge). The image forming unit 1a includes a photosensitive drum 3a as an image bearing member. The photosensitive drum 3a is rotated at a predetermined process speed. The photosensitive drum 3a is charged to uniform negative potentials by a charge roller that charges the photosensitive drum 3a. The surface of the charged photosensitive drum 3a is exposed by an exposure device 6. The exposure device 6 exposes the photosensitive drum 3a by using laser beams ON/OFF-modulated according to image data, thereby forming an electrostatic latent image on the photosensitive drum 3a. A developing device that develops the toner image of yellow develops the electrostatic image as the toner image of yellow on the photosensitive drum 3a. A primary transfer roller 2a presses the intermediate transfer belt 2, to which the toner image is transferred, thereby forming a primary transfer portion Ta, where the toner image is transferred to the intermediate transfer belt 2 from the photosensitive drum 3a. A positive direct-current voltage is applied to the primary transfer roller 2a. As a consequence, at the primary transfer portion Ta, a negative toner image borne on the photosensitive drum 3a is transferred to the intermediate transfer belt 2.

The image forming units 1b, 1c, and 1d similarly form the toner images of magenta, cyan, and black on corresponding photosensitive members 3b, 3c, and 3d. Further, corresponding primary transfer rollers 2b, 2c, and 2d similarly transfer the toner images formed on the photosensitive members 3b, 3c, and 3d to the intermediate transfer belt 2. When forming a color image, the image forming units 1b to 1d perform image formation operations for overlapping the toner images with different colors on the intermediate transfer belt 2.

The intermediate transfer belt 2 is an endless belt member including a base material containing polyimide. The intermediate transfer belt 2 is stretched by a tension roller 27 that keeps tension of the intermediate transfer belt 2, a driving roller 26 that drives the intermediate transfer belt 2, a secondary-transfer inside roller 25, and tension rollers 28 and 29. Further, the intermediate transfer belt 2 is movable by the driving roller 26 in a direction of an arrow R2. The tension roller 27, which is arranged between the tension roller 28 and the driving roller 26, presses the intermediate transfer belt 2 towards the outside, thereby applying tension of 30 N (3 kgf) to the intermediate transfer belt 2. An angle at which the driving roller 26 is wound around the intermediate transfer belt 2 is set to at least 90 degrees or more. As a consequence, the driving roller 26 cannot be slippery on the intermediate transfer belt 2.

A draw-out roller 8 draws out a recording material P one by one from a recording material cassette 4, and a registration roller 9 carries the recording material P to a secondary transfer portion T2, where the toner image is transferred thereto. The registration roller 9 sends the recording material P to the secondary transfer portion T2 at a timing when the toner image on the intermediate transfer belt 2 reaches the secondary transfer portion T2.

A secondary-transfer outside roller 22 comes into contact with the intermediate transfer belt 2, thereby forming the secondary transfer portion T2, where the toner image is transferred to the recording material P. The secondary-transfer inside roller 25 is arranged opposite the position of the secondary-transfer outside roller 22, to sandwich the intermediate transfer belt 2. A positive direct-current voltage is applied to the roller secondary-transfer outside 22 from a power source (not illustrated). The secondary-transfer inside roller 25 is grounded. As a consequence, a transfer electrical field for transferring the toner image is generated between the secondary-transfer inside roller 25 and the secondary-transfer outside roller 22. At the secondary transfer portion T2, the toner image is transferred to the recording material P.

The recording material P to which the toner image is transferred is conveyed to a fixing device 5 that fixes the toner image. The fixing device 5 forms a fixing nip portion including a fixing roller 5a with a heater and a pressing roller 5b. The recording material P is nipped by the fixing nip portion, and the toner image is thus dissolved with heat and pressure. The toner image is thus fixed to the recording material P.

The moving intermediate transfer belt 2 can be deviated in a direction vertical to a movement direction of the intermediate transfer belt 2. Therefore, it is desirable to provide a steering device that steers the intermediate transfer belt 2 in a width direction thereof in order to suppress the deviation in the width direction of the intermediate transfer belt 2. According to the present exemplary embodiment, an intermediate transfer unit 20 including the intermediate transfer belt 2 is configured to enable the driving roller 26 to function as a steering roller.

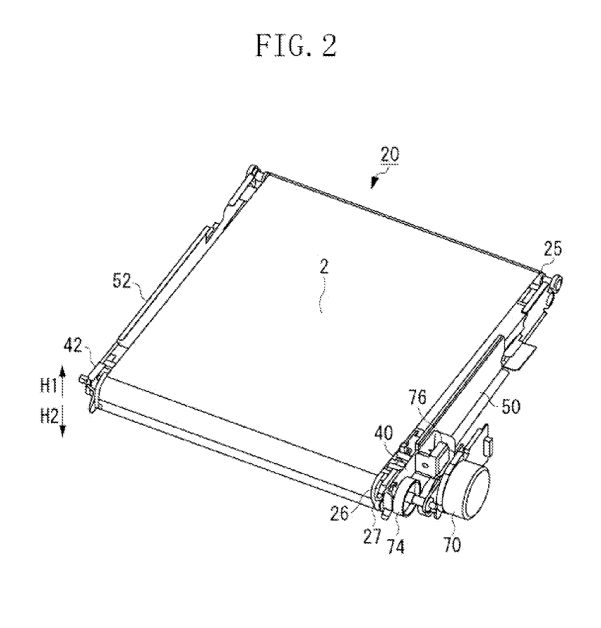

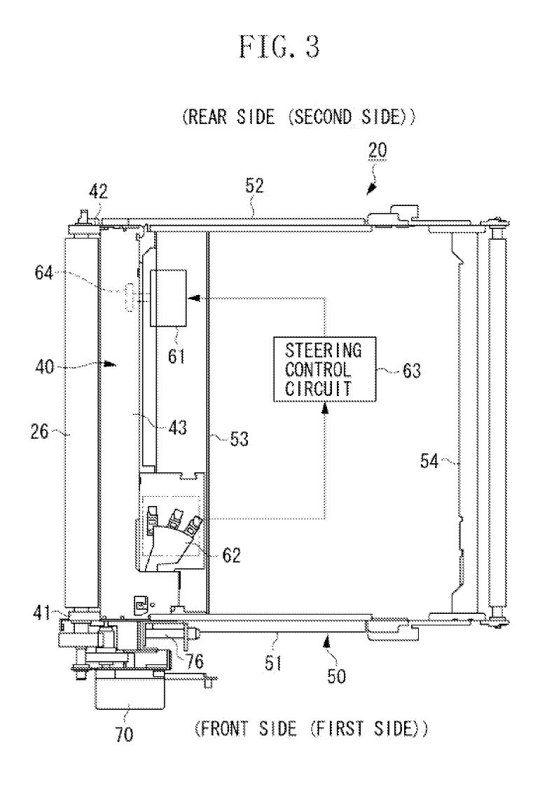

The intermediate transfer unit 20 including the intermediate transfer belt 2 is described with reference to FIGS. 2 and 3. The intermediate transfer unit 20 is a replaceable unit, and is arranged above the image forming units 1a, 1b, 1c, and 1d. Further, the intermediate transfer unit 20 includes a first frame 50 that supports the secondary-transfer inside roller 25, the primary transfer rollers 2a, 2b, 2c, and 2d, and the tension rollers 28 and 29, and a second frame 40 that supports the driving roller 26 and the tension roller 27. On the front side of the second frame 40 in a width direction thereof, a driving motor 70 is arranged as a driving source for supplying driving force to the driving roller 26.

The first frame 50 includes a side plate 51 arranged on a front side (first side) in a width direction thereof, a side plate 52 arranged on a rear side (second side) in the width direction, and beam plates 53 and 54 that connect the side plate 51 with the side plate 52.

The second frame 40 includes a side plate 41 arranged on the first side in a width direction thereof, a side plate 42 arranged on the second side thereof, and a beam plate 43 that connects the side plate 41 with the side plate 42. The beam plates 53, 54, and 43 provide rigidity required for a steering operation to the first and second frames 50 and 40.

A rotary shaft 76 rotates the side plate 41 of the second frame 40. The second frame 40 is supported by the first frame 50 on the first side via the rotary shaft 76. On the second side, the position of the second frame 40 is not fixed. That is, on the second side, the second frame 40 is moved in a direction H1 or a direction H2 opposite to the direction H1, and is thus inclined relative to the first frame 50.

The second frame 40 includes gears 74 and 75 that transmit the driving force from the driving motor 70 to the driving roller 26. Therefore, even if the second frame 40 is inclined, a positional relationship between the driving motor 70, the gears 74 and 75, and the driving roller 26 is not changed. Thus, unstable rotation of the driving roller 26 is suppressed even when the second frame 40 is inclined.

The driving motor 70 is arranged on the rotary shaft 76 on the opposite side of the driving roller 26 in the width direction. As a result, a direction of rotational moment generated in the second frame 40 with self weight of the driving motor 70 is opposite to that of rotational moment generated in the second frame 40 with self weight of the driving roller 26. Thus, a position of the second frame 40 is easily stable.

Further, an eccentric cam 64 that comes into contact with the beam plate 43 is arranged near the side plate 42 in the width direction. A steering motor 61 is a driving source that is arranged on the beam plate 53 of the first frame 50 and drives the eccentric cam 64.

When the steering motor 61 drives the eccentric cam 64, the beam plate 42 of the second frame 40 is moved. As a consequence, the driving roller 26 is inclined.

A position of the first frame 50 to which the steering motor 61 is arranged is fixed to the device body. Therefore, the steering motor 61 is stably driven.

A control circuit 63 functions as a steering control unit that controls the steering motor 61. The control circuit 63 receives positional information from a belt position detection device 110 that detects a position of the intermediate transfer belt 2 in the width direction. The control circuit 63 moves the steering motor 61 based on the positional information from the belt position detection device 110. Thus, alignment of the steering roller 26 is changed, thereby correcting the deviation of the intermediate transfer belt 2. The details of the belt position detection device 110 are described below.

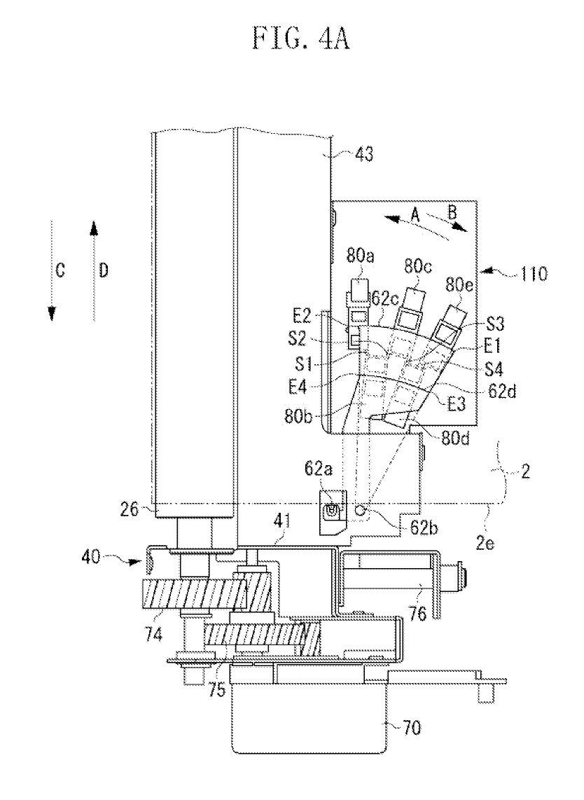

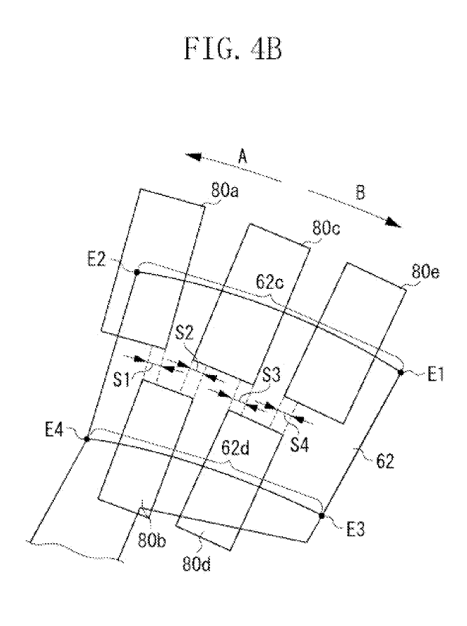

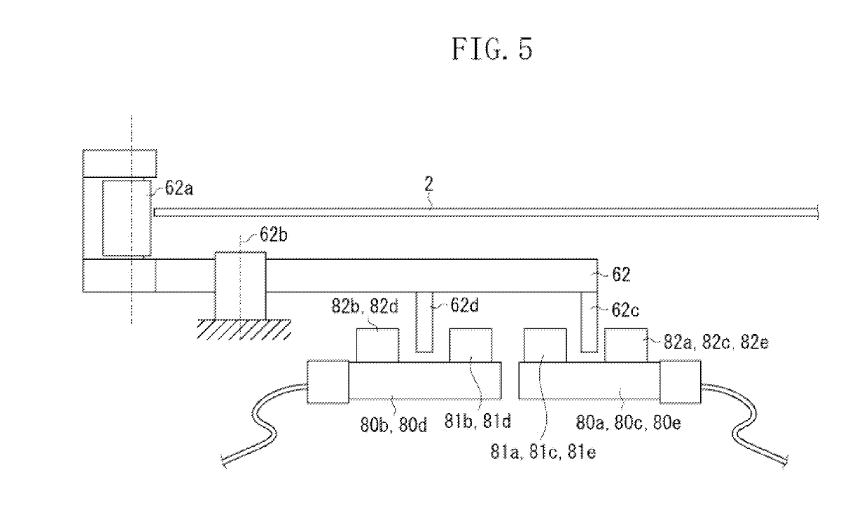

According to the present exemplary embodiment, the steering motor 61 is controlled based on a detection result by the belt position detection device 110. The details of a configuration of the belt position detection device 110 according to the present exemplary embodiment are described with reference to FIGS. 4A and 4B.

An arm 62 is rotatable around a rotary center 62b in a circumferential direction thereof. The arm 62 includes a contact roller 62a functioning as a contact unit that comes into contact with an end of the intermediate transfer belt 2 in the width direction. When the contact roller 62a comes into contact with the end of the intermediate transfer belt 2, the arm 62 follows movement of the intermediate transfer belt 2 in the width direction and is thus rotated around the rotary center 62b in the circumferential direction. When the intermediate transfer belt 2 is moved in a direction C in the width direction, the arm 62 is rotated in a direction A in the circumferential direction. When the intermediate transfer belt 2 is moved in a direction D in the width direction, the arm 62 is rotated in a direction B in the circumferential direction.

Further, the arm 62 includes a projection 62c to be projected to the rotary center 62b on a side that is opposite to the contact roller 62a and that does not face a rear surface of the intermediate transfer belt 2. To detect the projection 62c, photosensors 80a, 80c, and 80e are arranged along a locus where the projection 62c is moved when the arm 62 is rotated in the circumferential direction. That is, the photosensors 80a, 80c, and 80e are arranged in the same position in a radial direction vertical to the circumferential direction in which the arm 62 is rotated, and are arranged in different positions in the circumferential direction in which the arm 62 is rotated. The photosensors 80a, 80c, and 80e are those integrated with light emission and light reception, including light emission units 81a, 81c, and 81e that emit light and light reception units 82a, 82c, and 82e that receive light from the light emission units 81a, 81c, and 81e. Thus, each of the photosensors 80a, 80c, and 80e includes a single detection unit. Light from the light emission units 81a, 81c, and 81e is constantly turned on. Therefore, when the projection 62c on the arm 62 passes through the photosensors 80a, 80c, and 80e, the projection 62c blocks the light from the light emission units 81a, 81c, and 81e, and the light does not reach the light reception units 82a, 82c, and 82e (which is in the off-state). On the other hand, when the projection 62c on the arm 62 does not pass through the photosensors 80a, 80c, and 80e, the projection 62c does not block the light from the light emission units 81a, 81c, and 81e, and the light reaches the light reception units 82a, 82c, and 82e (which is in the on-state). In other words, the projection 62c functions a detected portion (first detected portion) detected by the photosensors 80a, 80c, and 80e. Combination of the on-state and the off-state of the photosensors 80a, 80c, and 80e is changed depending on the position of the arm 62. When the arm 62 is moved in the direction A in FIG. 4B, the photosensors 80e, 80c, and 80a are sequentially switched on in order thereof. Based on the combination of the on-state and the off-state of the photosensors 80a, 80c, and 80e, the position of the intermediate transfer belt 2 can be detected in real time.

For fine detection of the position of the intermediate transfer belt 2, an interval between the photosensors 80a, 80c, and 80e can be narrowed in the movement direction of the arm 62. However, the photosensors 80a, 80c, and 80e are arranged along the locus of the common projection 62c formed with the movement of the arm 62. Therefore, if the interval between the photosensors 80a, 80c, and 80e in the movement direction of the arm 62 is tried to be narrowed, there is a possibility that space necessary for arranging an arrangement tool of the photosensors 80a, 80c, and 80e cannot be reserved. Also, an arrangement interval between the photosensors 80a, 80c, and 80e can be limited depending on the size of an external shape of the photosensor 80a, 80c, or 80e in the movement direction of the arm 62. Thus, the arrangement interval between the photosensors 80a, 80c, and 80e cannot be narrowed and the fine detection cannot be performed.

According to the present exemplary embodiment, a projection 62d is arranged in a position different from that of the projection 62c in a radial direction vertical to the circumferential direction in which the arm 62 is rotated. Further, as a photosensor that detects the projection 62d, photosensors 80b and 80d are arranged along a movement locus of the projection 62d. That is, the photosensors 80b and 80d are arranged in the same position in the radial direction vertical to the circumferential direction in which the arm 62 is rotated, and are arranged in different positions in the circumferential direction in which the arm 62 is rotated. Furthermore, the photosensor 80b is arranged between the photosensors 80a and 80c in the circumferential direction in which the arm 62 is rotated. In addition, the photosensor 80d is arranged between the photosensors 80c and 80e in the circumferential direction in which the arm 62 is rotated.

Thus, with the configuration including the arm 62 that is moved in contact with the end of the intermediate transfer belt 2 to determine the position of the intermediate transfer belt 2 in the width direction and a plurality of photosensors 80a to 80e that detect the position of the arm 62, the arrangement interval between the photosensors 80a to 80e can be narrowed in the movement direction of the arm 62.

For a period between a time when the photosensor 80a detects the projection 62c and a time when the photosensor 80c detects the projection 62c, the photosensor 80b detects the projection 62d. For a period between a time when the photosensor 80c detects the projection 62c and a time when the photosensor 80e detects the projection 62c, the photosensor 80d detects the projection 62d. That is, the projections 62c and 62d are alternately detected and the detection thus becomes fine.

The photosensors 80b and 80d have a similar configuration to those of the photosensors 80a, 80c, and 80e. The photosensors 80b and 80d respectively include light emission units 81b and 81d and light reception units 82b and 82d. The projection 62d functions as a detected portion (second detected portion) that is detected by the photosensors 80b and 80d.

In the circumferential direction in which the arm 62 is rotated, the photosensors 80a, 80b, 80c, 80d, and 80e are arranged at an equal interval. This is because the position of the intermediate transfer belt 2 in the width direction is detected at an equal interval.

As viewed from the rotational center 62b, the projection 62d overlaps the projection 62c. Thus, a shadow of the projection 62d projected in the radial direction overlaps a shadow of the projection 62c in the radial direction. That is, on a line that connects one end E1 of the projection 62c in the movement direction of the arm 62 to the rotational center 62b, one end E3 of the projection 62d in the movement direction of the arm 62 is positioned. On a line that connects another end E2 of the projection 62c in the movement direction of the arm 62 to the rotational center 62b, another end E4 of the projection 62d in the movement direction of the arm 62 is positioned.

According to the present exemplary embodiment, in the circumferential direction in which the arm 62 is rotated, the external shape of the photosensor 80a is arranged to partly overlap the external shape of the photosensor 80b. Thus, a shadow of the external shape of the photosensor 80a projected in the radial direction overlaps a shadow of the external shape of the photosensor 80b projected in the radial direction. A region S1 is the region where the external shape of the photosensor 80a partly overlaps the external shape of the photosensor 80b in the movement direction of the arm 62. The reason is as follows. If the photosensors 80a and 80b are arranged in a straight line, the fine detection finer than the size of external shapes of the photosensors 80a and 80b cannot be performed. If the external shapes of the photosensors 80a and 80b are arranged to partly overlap each other, the finer detection can be achieved. Similarly, in the circumferential direction in which the arm 62 is rotated, regions S2 to S4 are formed. The region S2 is the region where the photosensor 80b partly overlaps the photosensor 80c, the region S3 is the region where the photosensor 80c partly overlaps the photosensor 80d, and the region S4 is the region where the photosensor 80d partly overlaps the photosensor 80e. In other words, in the circumferential direction in which the arm 62 is rotated, the arrangement interval between adjacent ones of the photosensors 80a to 80e is narrower than the size of the external shape of photosensors 80a to 80e.

According to the present exemplary embodiment, the regions S1, S2, S3, and S4 that partly overlap each other are formed. In the circumferential direction, the arrangement interval between adjacent ones of photosensors 80a to 80e is narrower than the size of the external shape of the photosensors 80a to 80e. However, the present invention is not limited to the configuration. For example, the arrangement interval between adjacent ones of the photosensors 80a to 80e can require a predetermined interval larger than the size of the external shape of the photosensors 80a to 80e according to the size of an attachment tool of the photosensors 80a to 80e or the space necessary for an attachment operation. The present invention may be applied to the configuration where, in the circumferential direction, an interval between adjacent ones of the photosensors 80a and 80b is larger than the external shape of the photosensors 80a and 80b.

As a fine detection method with a configuration where the photosensors 80a to 80e are arranged in a straight line, the photosensors 80a to 80e and the projections 62c and 62d can be kept away from the rotary center 62b of the arm 62. However, in this case, centrifugal force generated to the arm 62 is increased due to the weight of the projections 62c and 62d. As a result, there is a possibility that the arm 62 cannot follow the movement of the intermediate transfer belt 2. According to the present exemplary embodiment, the increase in distance between the projections 62c and 62d and the rotary center 62b of the arm 62 is suppressed. This thereby suppresses a decrease in followability of the arm 62 relative to the movement of the intermediate transfer belt 2.

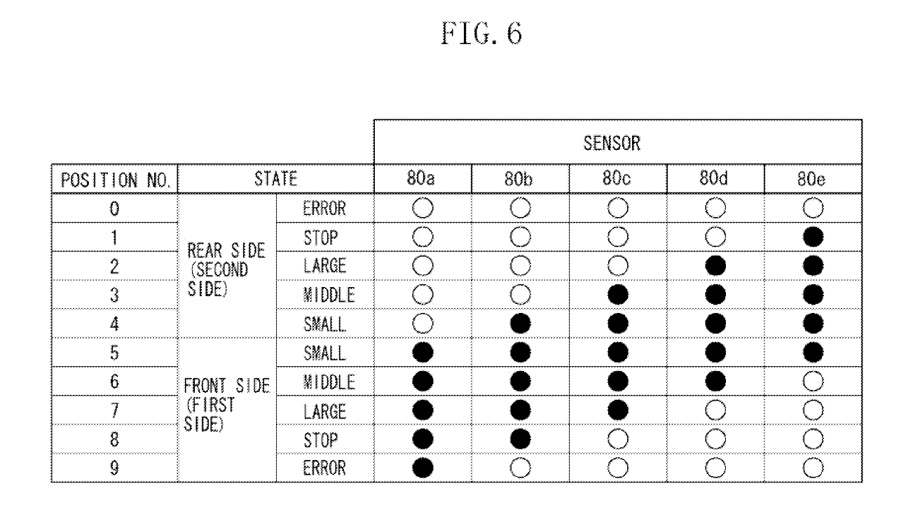

FIG. 6 illustrates a relationship between the combination of the on-state and the off-state of the photosensors 80a to 80e and the position of the intermediate transfer belt 2 in the width direction. A white circle indicates the on-state, and a black circle indicates the off-state. A position number (No.) indicates the position of the intermediate transfer belt 2 in the width direction. As the position No. is larger, the intermediate transfer belt 2 is positioned nearer the first side, on which the driving roller 70 is arranged, in the width direction. If the position No. is different by 1, this means that the position of the intermediate transfer belt 2 deviates by 1 mm in the width direction. More particularly, at position No. 0, the intermediate transfer belt 2 greatly deviates to the second side in the width direction. At this time, all the photosensors 80a, 80b, 80c, 80d, and 80e are in the on-state. Position No. 1 deviates to the first side from position No. 0 by 1 mm in the width direction. At this time, the photosensors 80a, 80b, 80c, and 80d are in the on-state, and the photosensor 80e is in the off-state. The position No. 2 deviates to the first side from the position No. 1 by 1 mm in the width direction. At this time, the photosensors 80a, 80b, and 80c are in the on-state, and the photosensors 80d and 80e are in the off-state. Position No. 3 deviates to the first side from the position No. 2 by 1 mm in the width direction. At this time, the photosensors 80a and 80b are in the on-state, and the photosensors 80c, 80d, and 80e are in the off-state. Position No. 4 deviates to the first side from the position No. 3 by 1 mm in the width direction. At this time, the photosensor 80a is in the on-state, and the photosensors 80b, 80c, 80d, and 80e are in the off-state. With respect to the position Nos. 5, 6, 7, 8, and 9, the combination of the on-state and the off-state thereof is similarly changed.

Between the position Nos. 4 and 5, the intermediate transfer belt 2 is at a home position in the center in the width direction. If the intermediate transfer belt 2 is at the position Nos. 4, 3, and 2, the intermediate transfer belt 2 can desirably be returned to the home position in the width direction. Then, the steering motor 61 is controlled to move the end of the driving roller 26 in the direction H2. As the position of the intermediate transfer belt 2 is sequentially changed to the position Nos. 4, 3, and 2, the steering motor 61 is controlled to further move the end of the driving roller 26 in the direction H2. In other words, as the deviation amount of the intermediate transfer belt 2 is larger with the sequential change in position of the intermediate transfer belt 2 to the position Nos. 4, 3, and 2, the inclination of the driving roller 26 is increased and force of recovering the deviation is thus strengthened. If the intermediate transfer belt 2 is at the position Nos. 5, 6, and 7, the intermediate transfer belt 2 can desirably be returned to the home position. The steering motor 61 is controlled to move the end of the driving roller 26 in the direction H1. As the position of the intermediate transfer belt 2 is sequentially changed to the position Nos. 5, 6, and 7, the steering motor 61 is controlled to further move the end of the driving roller 26 in the direction H1. In other words, as the deviation amount of the intermediate transfer belt 2 is larger with the sequential change in position of the intermediate transfer belt 2 to the position Nos. 5, 6, and 7, the inclination of the intermediate transfer belt 2 is increased and force of recovering the deviation of the intermediate transfer belt 2 is thus strengthened. If the intermediate transfer belt 2 is at the position Nos. 1 and 8, the deviation amount of the intermediate transfer belt 2 is larger. Therefore, the image forming apparatus is suspended. Further, if the deviation amount of the intermediate transfer belt 2 further increases and the intermediate transfer belt 2 is at the position Nos. 0 and 9, the image forming apparatus outputs an error message.

According to the present exemplary embodiment, the position of the intermediate transfer belt 2 is finely detected, and the steering control is further finely performed. As a result, the deviation of the intermediate transfer belt 2 to the end thereof can be recovered without delay. Also, with the fine steering control, the deviation of the image position can be prevented.

According to the present exemplary embodiment, the arm 62 and the photosensors 80a, 80b, 80c, 80d, and 80e are fixed to the second frame 40. Therefore, if the driving roller 26 is inclined and the position of the end of the intermediate transfer belt 2 is thus moved, the positional relationship between the arm 62 and the end of the intermediate transfer belt 2 is not greatly changed. This can suppress a decrease in accuracy for detecting the position of the intermediate transfer belt 2 even if the end of the intermediate transfer belt 2 is bent.

Further, the contact roller 62a of the arm 62 comes into contact with the end of the intermediate transfer belt 2 near the driving roller 26, on the upstream side of the driving roller 26 in the movement direction of the intermediate transfer belt 2. Therefore, at the contact position of the contact roller 62a, the edge of the intermediate transfer belt 2 is stable without a flap, thereby suppressing an error increase in detecting the position of the intermediate transfer belt 2.

According to the present exemplary embodiment, the arm 62 is rotated. However, the present invention is not limited to this configuration. Alternatively, the arm 62 can be slid.

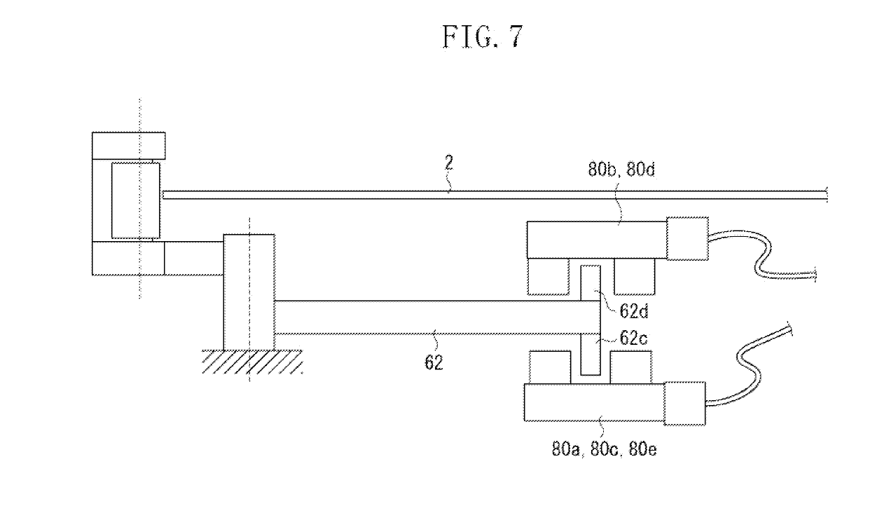

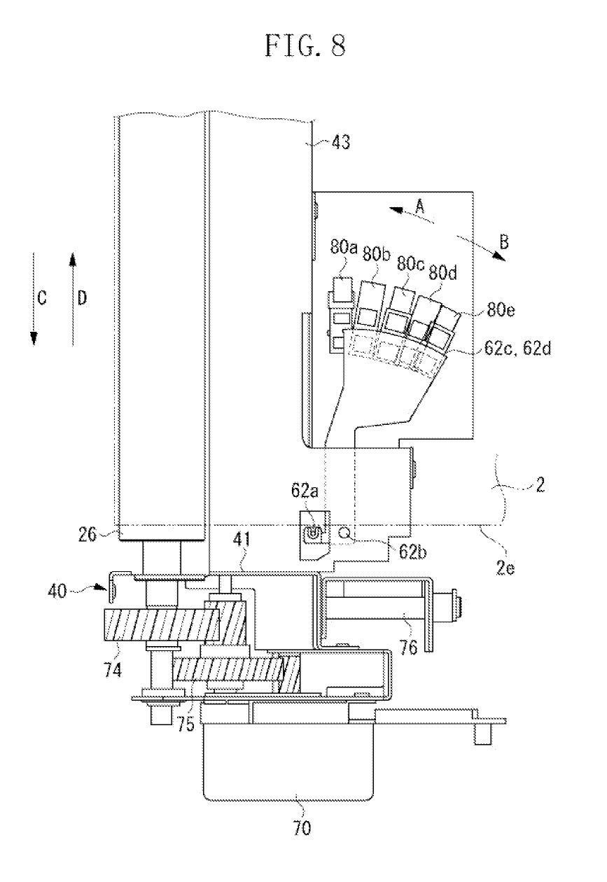

According to the first exemplary embodiment, the projection 62d is disposed on the surface on the same side of the surface on which the projection 62c is arranged on the arm 62. Further, the projection 62d is disposed in the position different from that of the projection 62c in the radial direction vertical to the circumferential direction in which the arm 62 is rotated. However, the present invention is not limited to this configuration. As illustrated in FIGS. 7 and 8, there may be a configuration that the projection 62d is provided on a surface (second detected portion) on the opposite side of the surface on which the projection 62c is arranged on the arm 62, and the projection 62d is disposed in a position different from that of the projection 62c in the vertical direction of the arm surface.

In this case, as illustrated in FIGS. 7 and 8, a shadow of the projection 62c projected in the vertical direction overlaps a shadow of the projection 62d projected in the vertical direction. In the circumferential direction in which the arm 62 is rotated, the photosensor 80b is arranged between the photosensors 80a and 80c. In the circumferential direction in which the arm 62 is rotated, the photosensor 80d is arranged between the photosensors 80c and 80e. The photosensors 80a, 80c, and 80e detect the projection 62c, and the photosensors 80b and 80d detect the projection 62d.

When the arm 62 is moved in a direction A, the on-state and the off-state of the photosensors 80a to 80e are sequentially switched in order of the photosensors 80e, 80d, 80c, 80b, and 80a, and the position of the arm 62 is determined. On the other hand, when the arm 62 is moved in a direction B, the on-state and the off-state of the photosensors 80a to 80e are sequentially switched in order of the photosensors 80a, 80b, 80c, 80d, and 80e, and the position of the arm 62 is determined. With this configuration, there is a merit to save space necessary for arranging the photosensors 80a to 80e in the radial direction vertical to the rotational direction of the arm 62.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-232037 filed Oct. 21, 2011, which is hereby incorporated by reference herein in its entirety.

What is claimed is:

1. A belt member driving device comprising:
a movable belt member;
a tension roller configured to stretch the belt member;
a driving source configured to drive the belt member;
a steering roller configured to stretch the belt member and to be able to incline relative to the tension roller to move the belt member being driven in a width direction of the belt member;
an arm configured to be movable with movement of the belt member in the width direction thereof while being in contact with an end of the belt member in the width direction thereof;
a first detected portion provided on the arm;
a second detected portion provided on the arm and disposed in a position different from that of the first detected portion in a direction perpendicular to a movement direction of the arm on a plane where the arm is moved;
a first sensor configured to detect the first detected portion;
a second sensor configured to detect the second detected portion, wherein the second sensor and the first sensor partly overlap each other in the movement direction of the arm as viewed in a direction perpendicular to the movement direction of the arm; and
a control unit configured to control inclination of the steering roller based on detection results by the first sensor and the second sensor.

2. The belt member driving device according to claim 1, wherein the arm include a rotary center, and
wherein the first sensor and the second sensor partly overlap each other in a circumferential direction in which the arm is rotated as viewed from the rotary center.

3. The belt member driving device according to claim 2, wherein the first sensor and the second sensor are disposed so as not to overlap each other in a direction perpendicular to the movement direction of the arm as viewed in the movement direction of the arm.

4. The belt member driving device according to claim 2, wherein the arm is configured to be rotated around the rotary center with the movement of the belt member in the width direction thereof while being in contact with the end of the belt member, and
wherein the arm includes the first detected portion and the second detected portion along a locus of the rotation.

5. The belt member driving device according to claim 2, wherein the first detected portion and the second detected portion are disposed so as to overlap each other in the circumferential direction as viewed from the rotary center.

6. The belt member driving device according to claim 1, wherein the first sensor includes a first detection portion configured to detect the first detected portion, and
wherein the second sensor includes a second detection portion configured to detect the second detected portion.

7. A belt member driving device comprising:
a movable belt member;
a tension roller configured to stretch the belt member;
a driving source configured to drive the belt member;
a steering roller configured to stretch the belt member and to be able to incline relative to the tension roller to move the belt member being driven in a width direction of the belt member;
an arm configured to be movable with movement of the belt member in the width direction thereof while being in contact with an end of the belt member in the width direction thereof;
a first detected portion provided on the arm;
a second detected portion provided on the arm and disposed in a position different from that of the first detected portion in a direction perpendicular to a movement direction of the arm on a plane where the arm is moved;
a first sensor configured to detect the first detected portion;
a second sensor configured to detect the first detected portion, wherein the second sensor is disposed in a position different from that of the first sensor in the movement direction of the arm as viewed in a direction perpendicular to the movement direction of the arm;
a third sensor configured to detect the second detected portion, wherein the third sensor is disposed between the first sensor and the second sensor in the movement direction of the arm as viewed in a direction perpendicular to the movement direction of the arm; and
a control unit configured to control inclination of the steering roller based on detection results by the first sensor, the second sensor, and the third sensor.

8. The belt member driving device according to claim 7, wherein the arm includes a rotary center, and
wherein the third censor is disposed between the first sensor and the second sensor in a circumferential direction in which the arm is rotated as viewed from the rotary center.

9. A belt member driving device comprising:
a movable belt member;
a tension roller configured to stretch the belt member;
a driving source configured to drive the belt member;
a steering roller configured to stretch the belt member and to be able to incline relative to the tension roller to move the belt member being driven in a width direction of the belt member;
an arm configured to be movable with movement of the belt member in the width direction thereof while being in contact with an end of the belt member in the width direction thereof, wherein the arm includes a first surface and a second surface as a rear surface side of the first surface;
a first detected portion provided on the first surface of the arm;
a second detected portion provided on the second surface of the arm;
a first sensor configured to detect the first detected portion;
a second sensor configured to detect the second detected portion, wherein the second sensor and the first sensor partly overlap each other as viewed in a direction perpendicular to a plane where the arm is moved; and
a control unit configured to control inclination of the steering roller based on detection results by the first sensor and the second sensor.

10. An image forming apparatus comprising:
the belt member driving device according to claim 1;
a toner image forming unit configured to form a toner image on the belt member; and
a transfer portion configured to transfer the toner image to a recording material from the belt member on which the toner image is formed.

11. An image forming apparatus comprising:
the belt driving device according to claim 7;
a toner image forming unit configured to form a toner image on the belt member; and
a transfer portion configured to transfer the toner image to a recording material from the belt member on which the toner image is formed.

12. An image forming apparatus comprising:
the belt driving device according to claim 9;
a toner image forming unit configured to form a toner image on the belt member; and
a transfer portion configured to transfer the toner image to a recording material from the belt member on which the toner image is formed.
